(19) United States
(12) Patent Application Publication
(10) Pub. No.: US 2006/0258391 A1
(43) Pub. Date: Nov. 16, 2006

(54) Mobile communications terminal and communication method thereof

(75) Inventor: Bo-Rah Lee, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/430,028

(22) Filed: May 9, 2006

(30) Foreign Application Priority Data
May 10, 2005 (KR) 10-2005-0038925

(51) Int. Cl. H04M 1/00

(52) U.S. Cl. 455/550.1

(57) ABSTRACT

A mobile communications terminal capable of performing communications by using at least two numbers according to a usage purpose, a communication method thereof, and a mobile communications system. In the communication method, at least one main number is received from a mobile communications provider, and at least one sub number is provided from a virtual private network. Accordingly, at least two phone numbers are used in different purposes thereby to provide a user's convenience. Also, a business call is performed by using a virtual private network, and thus a security is enhanced.

### BACKGROUND OF THE INVENTION

1. Field of the Invention

The present invention relates to a mobile communications terminal, and more particularly, to a mobile communications terminal capable of performing a communication by using at least two different numbers according to a usage purpose and a communication method thereof.

2. Description of the Background Art

As a mobile communications technique and a technique for manufacturing a mobile communications terminal develop, a mobile communications terminal is being widely used by many peoples and most of people carry at least one mobile communications terminal these days. As the mobile communications terminal is commonly used, the peoples utilize it not only for a personal purpose but also for a business purpose.

Generally, one mobile communications terminal is provided with one mobile communications service subscription number. Accordingly, the number of users who separately possess two mobile communications terminals for a personal purpose and a business purpose is increasing significantly. However, when a user possesses two mobile communications terminals, a cost for an added mobile communications terminal and a fee provided to each mobile communications terminal according to a mobile communications service are additionally charged to the user or a company to which the user belongs. Furthermore, when a user makes a business call with using the mobile communications service, a security problem is caused.

### SUMMARY OF THE INVENTION

One aspect of the present invention involves the recognition by the present inventors of the drawbacks in the related art, as explained above. Based upon such recognition, improvements in utilizing at least two numbers for mobile terminals can be achieved according to the present invention.

Certain features that may be part of the utilizing at least two numbers of the mobile terminals will not be described in much detail, merely to prevent the characteristics of the present invention from being obscured. However, such additional features may also be part of the utilizing at least two numbers of the mobile communications system and method of the present invention, as would be understood by those skilled in the art.

Therefore, an object of the present invention is to provide a mobile communications terminal capable of performing a communication by using at least two numbers according to a usage purpose and a communication method thereof.

Another object of the present invention is to provide a mobile communications terminal capable of enhancing a security at the time of making a call that requires a security and a communication method thereof.

To achieve these and other advantages and in accordance with the purpose of the present invention, as embodied and broadly described herein, there is provided a mobile communications terminal, comprising: a transceiver for transmitting and receiving a signal; a storage unit for storing information relevant to at least one main number provided from a mobile communications provider and at least one sub number using a virtual private network; a controller for controlling communication to be performed by using different communications networks according to the main or sub numbers at the time of receiving a signal, and controlling communications to be performed by using different communications networks according to a communication mode or a calling number at the time of transmitting a signal; and a display unit for providing a user's interface.

Preferably, if a communication mode is converted into a virtual private network (VPN) mode or a calling number is a preset number using the VPN mode at the time of a call transmission or if a received number is matched with the sub number provided from the VPN at the time of a call reception, the controller enables a voice calling with another party by a call connection with the another party's terminal set according to a path of the VPN.

To achieve these and other advantages and in accordance with the purpose of the present invention, as embodied and broadly described herein, there is also provided a communication method for a mobile communications terminal, comprising: receiving at least one main number from a mobile communications provider; receiving at least one sub number from a virtual private network; and performing a voice calling with another party's terminal by using one of the main number and the sub number.

Preferably, the steps of making a voice calling by using the sub number comprises connecting a virtual private network at the time of transmitting and/or receiving a call signal; and making a voice calling with another party by a call connection with the another party's terminal set according to a path of the virtual private network.

To achieve these and other advantages and in accordance with the purpose of the present invention, as embodied and broadly described herein, there is still also provided a mobile communications system, comprising: a mobile communications provider for providing at least one main number for mobile communications service; a virtual private network for providing at least one sub number for network voice service based on Voice Over Internet Protocol (VoIP); and a mobile communications terminal for receiving the main number and the sub number from the mobile communications provider and the virtual private network, and performing a voice calling by using one of the numbers.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary construction view showing a mobile communications terminal according to the present invention;

FIG. 2A and FIG. 2B show an exemplary view of a calling process using a number provided from a mobile communications provider according to the present invention;

FIG. 3A and FIG. 3B show an exemplary view of a virtual private network (VPN) connection process according to the present invention;

FIG. 4A and FIG. 4B show an exemplary view of a call connection process based on a virtual private network according to a first embodiment of the present invention;

FIG. 5A and FIG. 5B show an exemplary view of a call connection process based on a virtual private network according to a second embodiment of the present invention; and

FIG. 6 is an exemplary flowchart showing a communication method for a mobile communications terminal according to the present invention.

### DETAILED DESCRIPTION OF PREFERRED EMBODIMENTS

Reference will now be made in detail to the preferred embodiments of the present invention, examples of which are illustrated in the accompanying drawings.

In a mobile communications terminal according to the present invention, at least two telephone numbers are provided. One number may be provided from a mobile communications provider and another number may be provided from a company by using a virtual private network (VPN) based on an internet protocol. Since the telephone numbers are different from each other, the mobile communications terminal (e.g., a cell phone, a PDA, a wireless communications device, etc.) may be provided with a number irrespective of a communications provider and may be provided with unlimited numbers according to a user's demand. Here, the virtual private network represents a communications network for implementing a private network by using a public network such as an Internet. Any other types of network, such as IEEE 802.11 wireless local area network (WLAN) network, a local based wireless private branch exchange (PBX) network, Wi-bro, or Brew, can be applied also to implement the virtual private network.

A mobile communications terminal according to the present invention is not provided with a dedicated virtual private network module therein, but is provided with a virtual private network client software thereby to maintain a security for contents based on an internet protocol security protocol (IPSec). The IPSec is a communication specification for implementing a secure communication on the Internet having a low security, which protects a wire tapping for data, etc. by implementing a virtual leased line on the Internet.

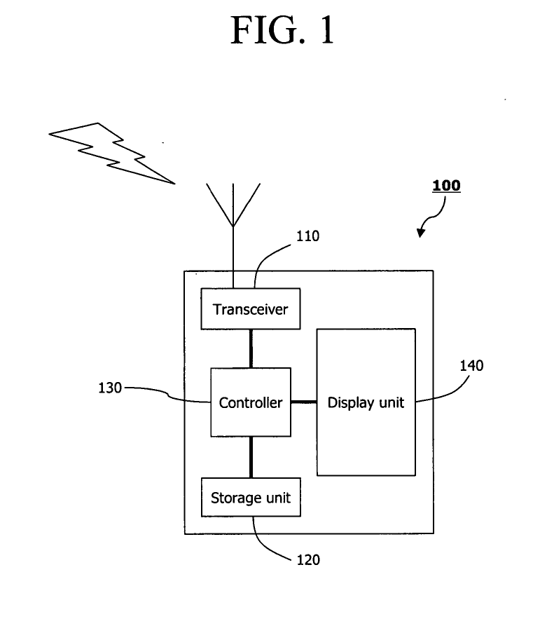

FIG. 1 is an exemplary construction view showing a mobile communications terminal according to the present invention.

As shown, the mobile communications terminal 100 comprises a transceiver 110 for transmitting and receiving a signal; a storage unit 120 for storing information regarding at least one main phone number provided from a mobile communications provider and at least one sub phone number to use a virtual private network; a controller 130 for handling communications to be performed by using different communications network modes according to the main or sub numbers at the time of receiving a signal, and controlling communication to be performed by using different communications network modes according to a communication network mode or a calling number at the time of transmitting a signal; and a display unit 140 for displaying a user interface for various functions and services. Here, the controller 130 may cooperate with different hardware and/or software components (modules) that may be part of the controller 130 and/or may be separate entities. The mobile communications terminal 100 may not be limited to comprise the elements described above, but also include many other limitations known in the art which are not shown or described in this.

The sub phone number using a virtual private network (VPN) may be a personal identification number provided from a company providing the VPN, and may be provided from a virtual private network processor of a company Intranet using the virtual private network via a virtual private network client software installed at the mobile communications terminal 100.

A length of the sub number using the virtual private network may be controlled according to a company size and the number of employees. For instance, a large company having three hundred thousand employees may be provided with three hundred thousand numbers such as ‘55100001’˜‘55400000’, and a small and medium company having 100 employees may be provided with 100 numbers such as ‘47101’˜‘47200’. The above case is a mere example, and can be varied according to contents of a VPN software installed at the mobile communications terminal.

If a communication mode is converted into a virtual private network (VPN) mode; a calling number is a preset number using the VPN mode at the time of a call transmission; or a received phone or terminal identification number is matched with the sub number provided from the VPN when receiving a call, the controller 130 enables a user to initiate a voice calling with the other party by a call connection with the another party's terminal set according to a path of the VPN. Herein, the voice calling is implemented by a network voice service based on a VoIP. The virtual private network is performed by connecting to an external internet thereby being allocated with an IP address, accessing to the virtual private network, requesting a virtual private network service, and performing a certification procedure by the mobile communications terminal.

At the time of the virtual private network connection, the controller 130 may display a business related graphic such as a name of a company that has provided a sub number, a text image such as ‘VPN’, a logo representing a company that has provided a sub number, or an icon [e.g. a neck tie shape icon] on the display unit 140 (e.g., CRT, LCD, PDP, LED, etc) in order to inform the user that the virtual private network is being used, that is, in order to inform the user that an originated call is a business call. The way to notify the user of the terminal in what kind of network mode the terminal is operating may not be limited to the elements described above, but also include many other limitations known in the art.

When a call is received from a main number that does not belong to the virtual private network or a call is transmitted by using a service network of a subscribed mobile communications provider, the controller 130 requests a call to a base station through the transceiver 110 and connects a call with another party's terminal to establish a voice calling connection with the another party. Herein, the voice calling is performed by a general voice calling service.

That is, the mobile communications terminal 100 provides a voice calling service by using a mobile phone number provided from a mobile communications provider, and provides a network voice calling service based on a VoIP by using a VoIP phone number provided from a virtual private network.

The mobile communications terminal 100 can comprise an input device (e.g., microphone, keypad, function buttons, touch-sensitive input device, etc. to allow audible, visual, and/or tactile inputs).

The mobile communications terminal 100 can comprise an output device (e.g., speaker, display unit, touch-screen, vibration unit, etc. to provide audible, visual, and/or tactile outputs), or can comprise an output port for outputting a signal by being connected to an external output device, such as a television, a monitor, an ear-set, or an external speaker.

The mobile communications terminal 100 can selectively comprise a storage medium inserting unit for inserting an external storage medium such as a memory card for data storage, or an additional unit such as a broadcasting reception module, a camera module, a Bluetooth module™, an infrared rays communications module, an MP3 module, and an internet banking module. In addition, the storage medium can include a virtual private network (VPN) software to allow the mobile communications terminal 100 to successfully pass an authentication and certification processes in order to connect to the central Internet backbone. When compared to a related mobile communications terminal, the mobile communications terminal in accordance with the present invention may not comprise any separate VPN or wireless network module to enable a call connection via the VPN.

Additionally, even though it would be too numerous to list all the features and variations that can be implemented in mobile communications terminals to accommodate and support the recent trend towards convergence of electronic and/or digital devices, those skilled in the art would easily understand that elements (i.e., hardware, software, or a combination thereof) that are equivalent to the function units and/or modules described above may be implemented in the mobile terminal 100 in accordance with the present invention.

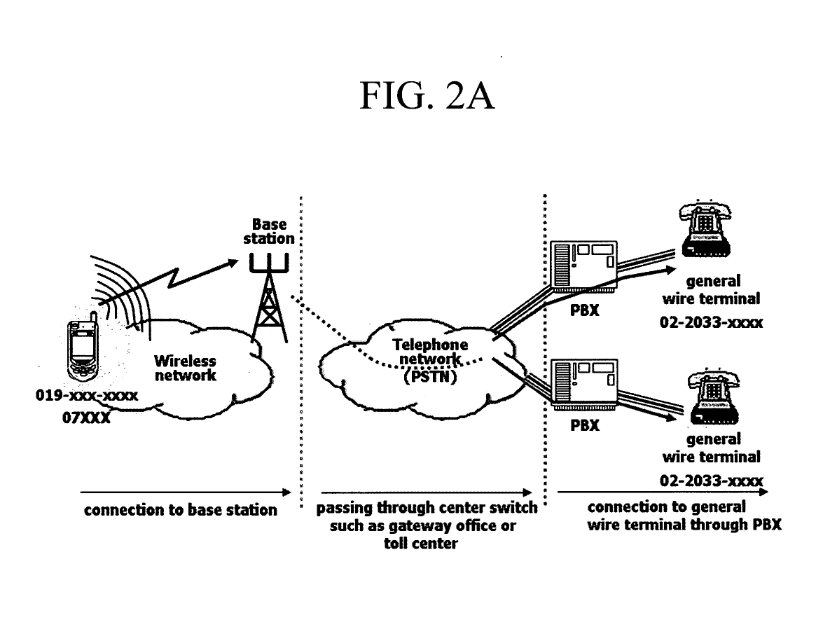

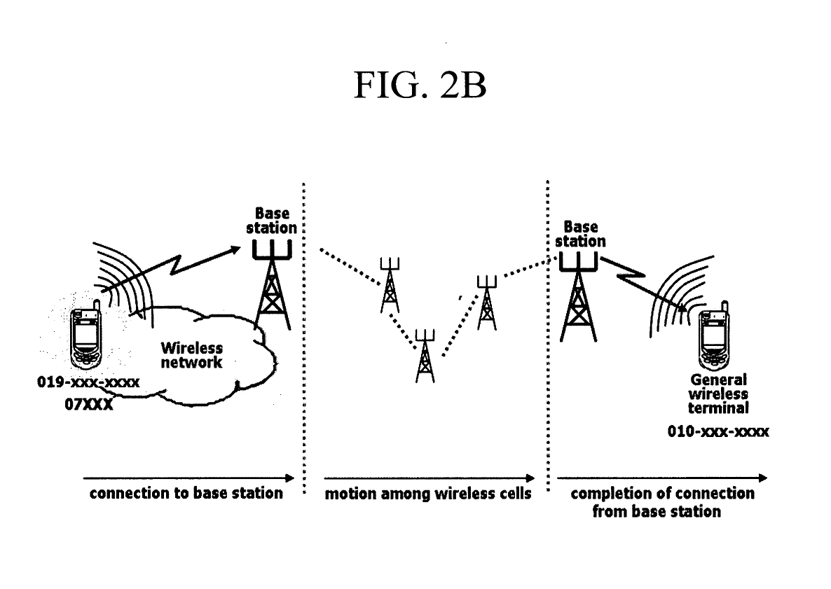

Referring to FIGS. 2A through 5B, a call connection process for a mobile communications terminal will be explained. For instance, a transmitting side mobile communications terminal was provided with a main number of ‘019-xxx-xxxx’ from a mobile communications provider, and was provided with a sub number of ‘07xxx’ from a virtual private network when a virtual private network software is installed at the mobile communications terminal.

FIGS. 2A and 2B are views showing a calling process using a mobile phone number provided from a mobile communications provider according to the present invention, in which FIG. 2A shows a calling process from a wireless terminal to a wired terminal and FIG. 2B shows a calling process from a wireless terminal to another wireless terminal.

As shown in FIG. 2A, a transmitting side mobile communications terminal transmits a signal for a call connection to a base station. Then, the mobile station transmits the signal to an exchanger through a phone network according to a phone number included in the signal transmitted from the transmitting side mobile communications terminal. The exchanger transmits the signal to a wired or landline terminal subscribed to have the corresponding phone number. When a recipient receives a call, the call is connected between the transmitting side mobile communications terminal and the receiving side terminal and thus a voice calling is performed.

Referring to FIG. 2B, the transmitting side mobile communications terminal transmits a signal for a call connection to a base station. Then, the mobile station transmits the signal to a final base station of an area where a receiving side mobile communications terminal subscribed to have the corresponding phone number is located via adjacent base stations according to a phone number included in the signal transmitted from the transmitting side mobile communications terminal. The final base station transmits the signal to the receiving side mobile communications terminal. When a recipient receives a call, the call is connected between the transmitting side mobile communications terminal and the receiving side mobile communications terminal and thus a voice calling is performed.

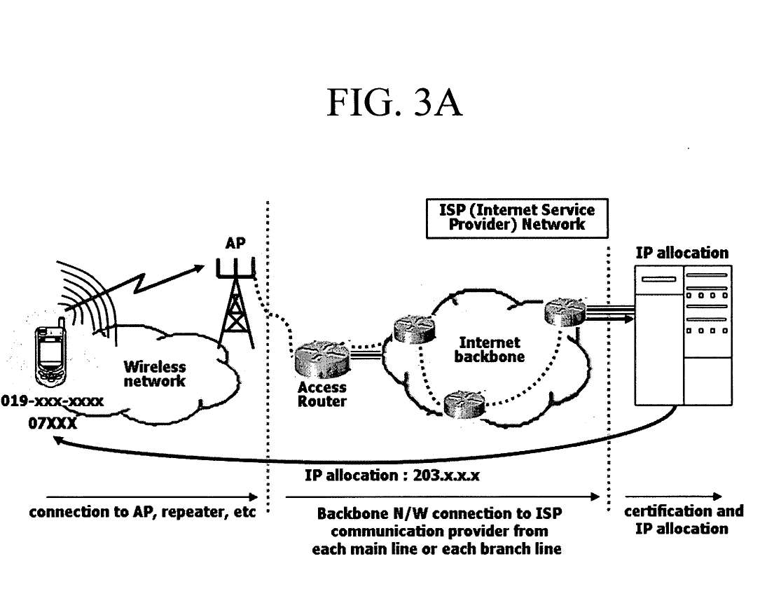

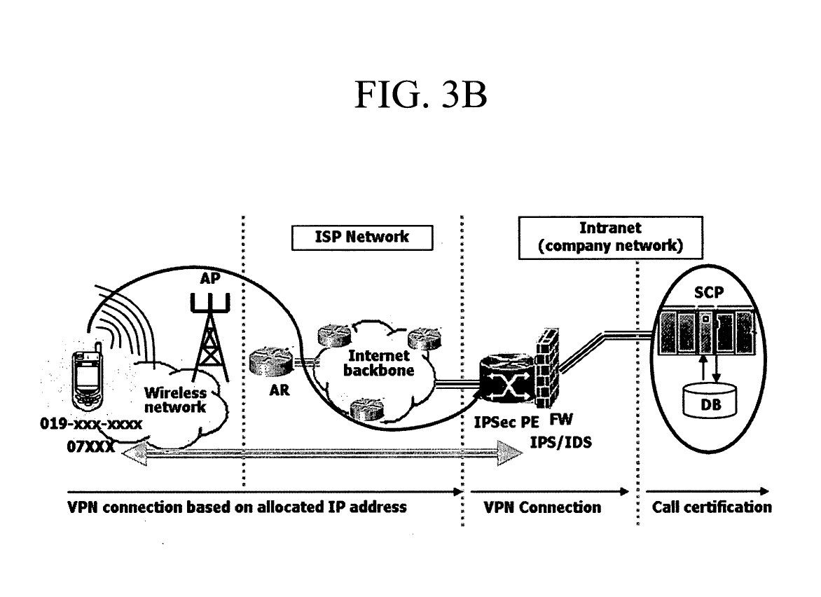

FIGS. 3A and 3B are exemplary views showing a process for a virtual private network connection according to another embodiment of the present invention, in which FIG. 3A shows an IP allocation process and an internet connection process and FIG. 3B shows a virtual private network service request by a company and a certification process.

As shown in FIG. 3A, a transmitting side mobile communications terminal transmits a signal for a call connection to a base station or access point (AP) through a wireless communications. Then, the base station connects an internet backbone network from each main line and each branch line of a connection network to an external internet communications provider, and transmits the signal to a server that allocates an internet protocol through the connected internet backbone network. The server performs a user authorization for the transmitting side mobile communications terminal, and then allocates an IP address.

Referring to FIG. 3B, the transmitting side mobile communications terminal accesses to a virtual private network (VPN) through the internet backbone according to the allocated IP address. Then, a security server of the VPN receives a signal for a call connection from the transmitting side mobile communications terminal thereby to set a security maintenance function, and transmits the signal to a certification server. The certification server can perform a user certification of the transmitting side mobile communications terminal on the basis of the received signal. The certification server may read information regarding the user from a database and certify the sub phone number provided from the virtual private network, thereby performing a certification process.

In accordance with the present invention, the mobile communications terminal including the VPN software can establish a network connection with the central Internet by using a central Transmission Control Protocol/Internet Protocol (TCP/IP) protocol (along with other protocols).

After the certification process is performed, a VPN connection by the transmitting side mobile communications terminal is performed. Once the VPN connection is performed, a call connection service based on the VPN can be used.

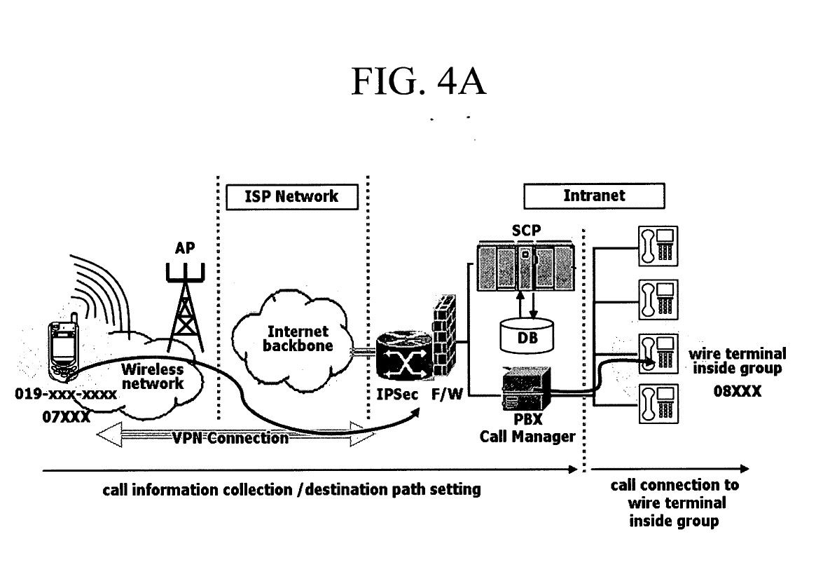

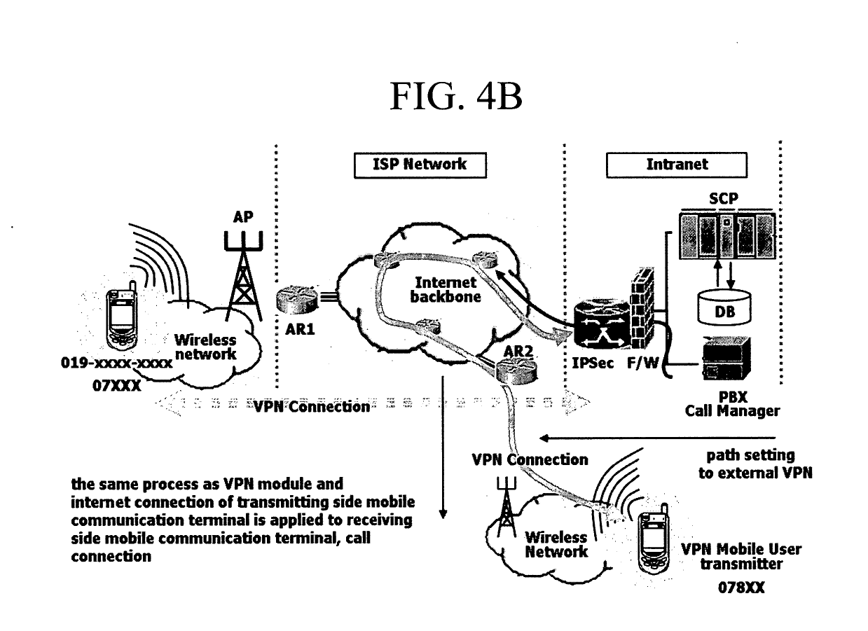

FIGS. 4A and 4B are views showing a call connection process based on the VPN according to another embodiment of the present invention, in which FIG. 4A shows a call connection process from a transmitting side mobile communications terminal using the VPN to a wire terminal using a company network, and FIG. 4B shows a call connection process from a transmitting side mobile communications terminal using the VPN to another mobile communications terminal to which a VPN number has been allocated.

As shown in FIG. 4A, if the transmitting side mobile communications terminal performs a VPN connection by certification processes of FIGS. 3A and 3B, the VPN collects call information and sets a destination path. Then, a call management exchanger of the VPN can set a call to a wired terminal having a corresponding phone number among wired terminals of a group. When a corresponding recipient receives a call, the call is connected between the transmitting side mobile communications terminal and the wired terminal of a company network and thus a voice calling is performed.

Referring to FIG. 4B, if the transmitting side mobile communications terminal performs a VPN connection by certification processes of FIGS. 3A and 3B, the call management exchanger of the VPN can set a path on an internet backbone network, an external internet network. Then, the call management exchanger can set a call with a receiving side mobile communications terminal subscribed to have a corresponding phone number via a wireless network through the internet backbone network. Herein, the receiving side mobile communications terminal can also undergo the same certification process for a VPN connection. When a corresponding recipient receives a call, a call between the transmitting side mobile communications terminal and the receiving side mobile communications terminal can be connected and thus a voice calling can be performed.

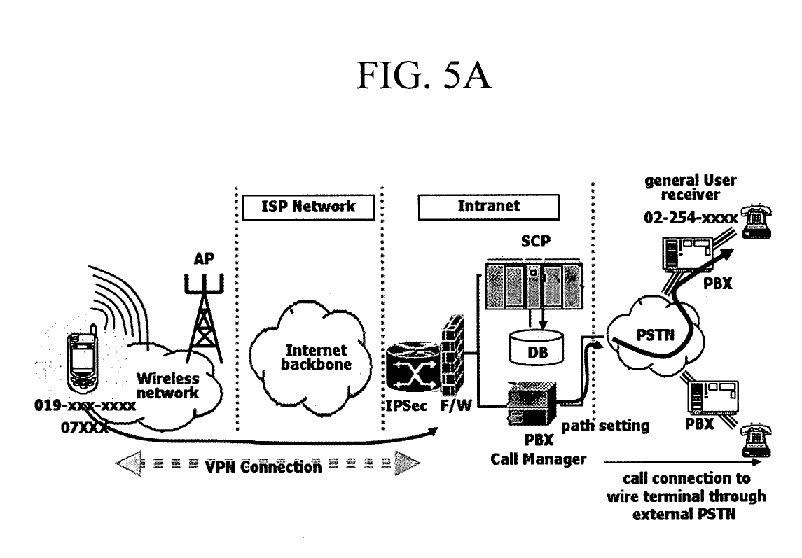

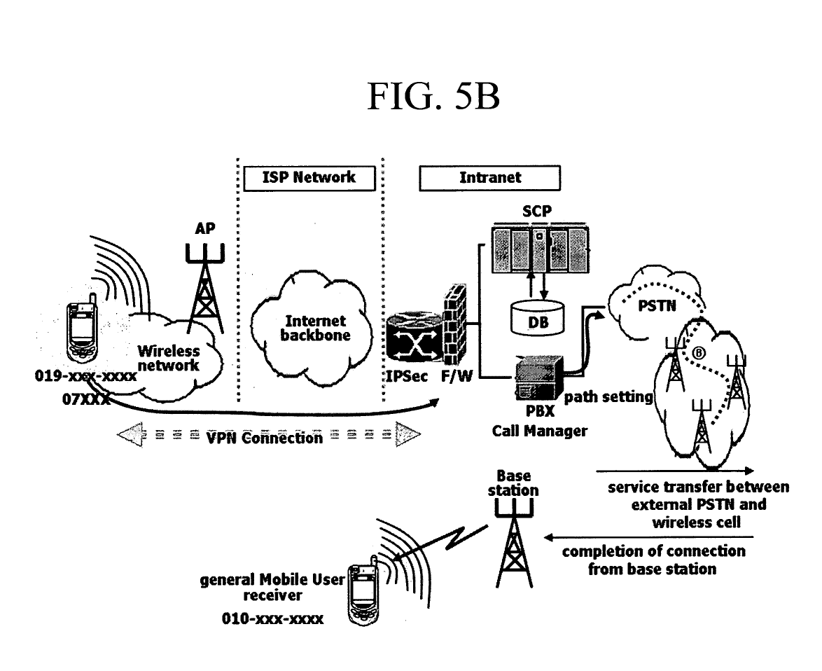

FIGS. 5A and 5B are views showing a call connection process based on a virtual private network according to still another embodiment of the present invention, in which FIG. 5A shows a call connection process from a transmitting side mobile communications terminal using a VPN to a general wire terminal, and FIG. 5B shows a call connection process from a transmitting side mobile communications terminal using a VPN to another mobile communications terminal.

As shown in FIG. 5A, if the transmitting side mobile communications terminal performs a VPN connection by certification processes of FIGS. 3A and 3B, a call management exchanger of the VPN sets a call path and sets a call with a corresponding phone number through an external phone network.

As shown in FIG. 5B, if the transmitting side mobile communications terminal performs a VPN connection by certification processes of FIGS. 3A and 3B, a call management exchanger of the VPN sets a call path and sets a call with an external phone network. Then, the call management exchanger transmits a signal for a call connection to a base station (a final base station) of an area where a receiving side mobile communications terminal subscribed to have a corresponding phone number through wireless cells. The final base station transmits the signal to the corresponding receiving side mobile communications terminal thereby to perform a call connection with the transmitting side mobile communications terminal.

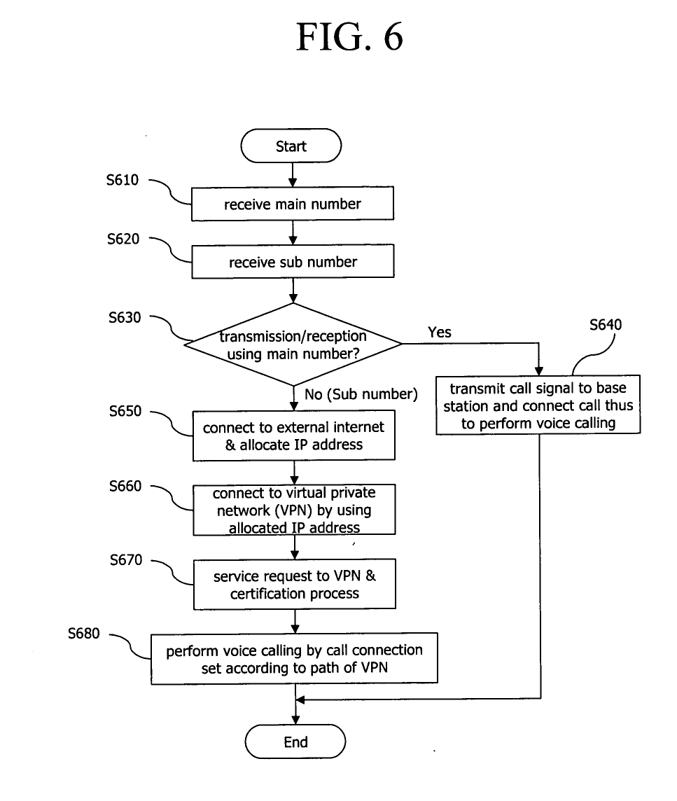

FIG. 6 is a flowchart showing a communications method for a mobile communications terminal according to the present invention.

Referring to FIG. 6, the mobile communications terminal receives at least one phone number (main number) from a subscribed mobile communications provider (S610). Then, the mobile communications terminal receives at least one sub number from a VPN processor of a company intranet using the VPN by a VPN client software installation (S620). Then, the mobile communications terminal performs a voice calling with another party's terminal by using one of the main number and the sub number. The mobile communications terminal judges whether a call transmission/reception is performed by using the main number or the sub number (S630). If it is determined that a call transmission/reception is performed by using the main number, the mobile communications terminal transmits a call signal to a base station and connects a call with a corresponding another party's terminal thereby to handle a voice calling (S640). On the contrary, if it is determined that a call transmission/reception is handled by using the sub number, the mobile communications terminal is connected to an external internet thereby to be allocated with an IP address (650). Then, the mobile communications terminal can be connected to the VPN by using the allocated IP address (S660). Then, the mobile communications terminal requests service from the VPN and undergoes a certification process (S670). After the mobile communications terminal establishes the VPN connection (S650˜S670), it handles a call connection with another party's terminal set according to a path of the VPN and thus performs a voice calling with another party (S680).

As aforementioned, in the mobile communications terminal and the communications method thereof according to the present invention, one mobile communications terminal is provided with at least two phone numbers thus to separately use the numbers for a personal purpose and a business purpose. Accordingly, First of all, a user needs not to purchase an additional mobile communications terminal. Second, a security of company is ensured since a company uses a business calling by using a VPN. Third, the company can pay the charge for the business calling only since a company can certify data usage charge for only a business calling. Fourth, since a VPN module chip is not mounted in the mobile communications terminal but a software is installed at the mobile communications terminal, allocating, deleting, and modifying numbers using the VPN are facilitated and a security is enhanced. Fifth, since the mobile communications terminal according to the present invention can perform even a voice calling service using a company VPN, an internal phone is not required at the company and a business affair is processed regardless of a place.

The present invention is described as being implemented in a general type mobile communications system. However, the features of the present invention may also be adapted and implemented in communications systems operating under other types of communications specifications (e.g., 3GPP, 3GPP2, 4G, IEEE, OMA, etc.), because the concepts and teachings of the present invention could be applied to various communications schemes that operate in a similar manner based upon common techniques.

To implement the various features described above, the present invention can employ various types of hardware and/or software components (modules). For example, different hardware modules may contain various circuits and components necessary to perform the steps of the above method. Also, different software modules (executed by processors and/or other hardware) may contain various codes and protocols necessary to perform the steps of the present invention method.

In accordance with the present invention, a mobile communications terminal may comprise a transceiver for transmitting and receiving a signal; a storage unit for storing information including at least one first identification number provided by a first wireless network mode provider and at least one second identification number provided by a second wireless network mode provider; a controller cooperating with the transceiver and the storage unit to selectively handle a call using at least one of the first wireless network mode and the second wireless network upon detecting whether the mobile communications terminal sends and/or receives calls via the at least one first identification number, the at least one second identification number or a combination thereof; and a display unit. The first wireless network mode can be a cellular network mode, and the controller can handle the call using the cellular network mode and the at least one first identification number is a mobile telephone number for the mobile communications terminal provided by a cellular network provider. The second wireless network mode can be a virtual private network (VPN) mode, and the at least one second identification number can be a personal identification number provided by a VPN processor through a VPN client software stored in the storage unit. In addition, the controller may handle the calls using the VPN mode upon detecting at least one of: a user of the mobile communications terminal selecting the VPN mode as the wireless network mode, an outgoing calling number being the personal identification number corresponding to the VPN mode at the time of a call transmission, and a received call number being the personal identification number corresponding to the VPN mode at the time of a call reception. The mobile communications terminal can be configured to be connected to an internet after transmitting a request for the VPN service if the mobile communications terminal is allocated with an internet protocol (IP) address and receives an authentication and certification from an internet service provider.

After a tunnel for the VPN connection is established, the mobile communications terminal can receive the authentication and certification through an IP security (IPSec) via the VPN client software. The voice calling is performed on the basis of network voice service based on VoIP. At the time of the VPN connection, the controller may inform the user of the VPN being used by displaying an image including information regarding a provider that has provided the at least one second identification number.

When a call is received from another mobile communications terminal allocated with a mobile phone number that does not belong to a virtual private network or a call is transmitted by using the cellular network mode, the controller can request a call connection signal to a base station via the transceiver and handles a voice calling with another party.

In accordance with the present invention, a method for a mobile communications terminal may comprise: receiving at least one main number from a mobile communications provider; receiving at least one sub number from a virtual private network (VPN); determining whether to send and/or receive a call signal with another party's mobile communications terminal by using one of the main number and the sub number; and handling the call signal based upon the determining.

If it is determined to send and/or receive the call signal with another party's mobile communications terminal by using the sub number, the method can establish a connection to a path of the VPN. The step of connecting to the VPN can further comprise: connecting the mobile communications terminal to a central internet backbone and receiving an IP address allocation; connecting the mobile communications terminal to the VPN by using the IP address allocation; and requesting a service to the VPN and performing a certification process by the mobile communications terminal. In addition, the method may further comprise, if it is determined to send and/or receive the call signal with another party's mobile communications terminal by using the main number, transmitting the call signal to a base station and handling a call connection with a corresponding another party's terminal to establish a voice calling, wherein the main number is a mobile telephone number for the mobile communications terminal provided by a cellular network provider.

The method can further comprise providing a security feature for establishing a connection between the mobile communications terminal and the VPN; using a VPN client software installed in the mobile communications terminal to communicate with an internet security (IPSec) server to receive a VPN call number certificate and a user authorization; and establishing a tunnel between the mobile communications terminal and an internet service provider. The providing a security feature can further comprise at least one of: providing an authorization code installed in the mobile communications to the IPSec server to receive a VPN call number certificate and a user authorization; and receiving at the mobile communications terminal a one time password (OTP) from one of the VPN provider and the IPSec server, and allowing the user to provide the OTP to one of the VPN provider and the IPSec server to receive a VPN call number certificate and a user authorization. The method may further comprise simultaneously sending and/or receiving calls using a cellular network mode and the VPN.

According to the present invention, a mobile communications system can comprise a mobile communications provider for providing at least one main number for mobile communications service; a virtual private network (VPN) for providing at least one sub number for network voice service based on VoIP; and a mobile communications terminal comprising, a transceiver for transmitting and receiving a signal; a storage unit for storing information including at least one first identification number provided by a first wireless network mode provider and at least one second identification number provided by a second wireless network mode provider; and a controller cooperating with the transceiver and the storage unit to perform, selectively handling a call using at least one of the first wireless network mode and the second wireless network upon detecting whether the mobile communications terminal sends and/or receives calls via the at least one first identification number, the at least one second identification number or a combination thereof.

The mobile communications system can further comprise: an Internet Service Provider server for allocating an IP address to the mobile communications terminal that handles a communication by using the personal identification number; and an internet backbone network for connecting the VPN with the mobile communications terminal on the basis of the allocated IP address. Here, the VPN can comprise: a security server for receiving a call connection signal from the mobile communications terminal connected through the internet backbone network, and setting a security maintenance function for received contents; a certification server for performing a user certification by receiving the signal from the security server; a database for storing and managing data regarding the user certification; and a call management exchanger for setting a call path according to a received number from the mobile communications terminal or a calling number to the mobile communications terminal, and setting a call to the set path.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile communications terminal comprising:
a transceiver for transmitting and receiving a signal;
a storage unit for storing information including at least one first identification number provided by a first wireless network mode provider and at least one second identification number provided by a second wireless network mode provider;
a controller cooperating with the transceiver and the storage unit to perform,
selectively handling a call using at least one of the first wireless network mode and the second wireless network upon detecting whether the mobile communications terminal sends and/or receives calls via the at least one first identification number, the at least one second identification number or a combination thereof; and
a display unit.

2. The mobile communications terminal of claim 1, wherein the first wireless network mode is a cellular network mode, and wherein the controller handles the call using the cellular network mode and the at least one first identification number is a mobile telephone number for the mobile communications terminal provided by a cellular network provider.

3. The mobile communications terminal of claim 1, wherein the second wireless network mode is a virtual private network (VPN) mode, and wherein the at least one second identification number is a personal identification number provided by a VPN processor through a VPN client software stored in the storage unit.

4. The mobile communications terminal of claim 3, wherein the controller handles the calls using the VPN mode upon detecting at least one of:
a user of the mobile communications terminal selecting the VPN mode as the wireless network mode,
an outgoing calling number being the personal identification number corresponding to the VPN mode at the time of a call transmission, and
a received call number being the personal identification number corresponding to the VPN mode at the time of a call reception.

5. Communications terminal of claim 3, wherein the mobile communications terminal is configured to be connected to an internet after transmitting a request for the VPN service if the mobile communications terminal is allocated with an internet protocol (IP) address and receives an authentication and certification from an internet service provider.

6. The mobile communications terminal of claim 5, wherein after a tunnel for the VPN connection is established, the mobile communications terminal receives the authentication and certification through an IP security (IPSec) via the VPN client software.

7. The mobile communications terminal of claim 3, wherein the voice calling is performed on the basis of network voice service based on VoIP.

8. The mobile communications terminal of claim 3, wherein at the time of the VPN connection, the controller informs the user of the VPN being used by displaying an image including information regarding a provider that has provided the at least one second identification number.

9. The mobile communications terminal of claim 2, wherein when a call is received from another mobile communications terminal allocated with a mobile phone number that does not belong to a virtual private network or a call is transmitted by using the cellular network mode, the controller requests a call connection signal to a base station via the transceiver and handles a voice calling with another party.

10. A method for a mobile communications terminal, comprising:
receiving at least one main number from a mobile communications provider;
receiving at least one sub number from a virtual private network (VPN);
determining whether to send and/or receive a call signal with another party's mobile communications terminal by using one of the main number and the sub number; and
handling the call signal based upon the determining.

11. The method of claim 10, wherein the sub number is a personal identification number provided from a VPN processor through a VPN client software installed at a mobile communications terminal.

12. The method of claim 10, further comprising:
If it is determined to send and/or receive the call signal with another party's mobile communications terminal by using the sub number, establishing a connection to a path of the VPN.

13. The method of claim 12, wherein the step of connecting to the VPN comprises:
connecting the mobile communications terminal to a central internet backbone and receiving an IP address allocation;
connecting the mobile communications terminal to the VPN by using the IP address allocation; and
requesting a service to the VPN and performing a certification process by the mobile communications terminal.

14. The method of claim 10, further comprising:
if it is determined to send and/or receive the call signal with another party's mobile communications terminal by using the main number, transmitting the call signal to a base station and handling a call connection with a corresponding another party's terminal to establish a voice calling, wherein the main number is a mobile telephone number for the mobile communications terminal provided by a cellular network provider.

15. The method of claim 10, further comprising:
providing a security feature for establishing a connection between the mobile communications terminal and the VPN;
using a VPN client software installed in the mobile communications terminal to communicate with an internet security (IPSec) server to receive a VPN call number certificate and a user authorization; and
establishing a tunnel between the mobile communications terminal and an internet service provider.

16. The method of claim 15, wherein the providing a security feature further comprises one of at least one of:
providing an authorization code installed in the mobile communications to the IPSec server to receive a VPN call number certificate and a user authorization; and
receiving at the mobile communications terminal a one time password (OTP) from one of the VPN provider and the IPSec server, and allowing the user to provide the OTP to one of the VPN provider and the IPSec server to receive a VPN call number certificate and a user authorization.

17. The method of claim 10, further comprising:
simultaneously sending and/or receiving calls using a cellular network mode and the VPN.

18. A mobile communications system, comprising:
a mobile communications provider for providing at least one main number for mobile communications service;
a virtual private network (VPN) for providing at least one sub number for network voice service based on VoIP; and
a mobile communications terminal comprising,
a transceiver for transmitting and receiving a signal;
a storage unit for storing information including at least one first identification number provided by a first wireless network mode provider and at least one second identification number provided by a second wireless network mode provider; and
a controller cooperating with the transceiver and the storage unit to perform,
selectively handling a call using at least one of the first wireless network mode and the second wireless network upon detecting whether the mobile communications terminal sends and/or receives calls via the at least one first identification number, the at least one second identification number or a combination thereof.

19. The mobile communications system of claim 18, wherein the at least one second identification number is a personal identification number provided from a virtual private network (VPN) processor through a VPN client software installed at the mobile communications terminal.

20. The mobile communications system of claim 19, further comprising:
an Internet Service Provider server for allocating an IP address to the mobile communications terminal that handles a communication by using the personal identification number; and
an internet backbone network for connecting the VPN with the mobile communications terminal on the basis of the allocated IP address.

21. The mobile communications system of claim 20, wherein the VPN comprises:
a security server for receiving a call connection signal from the mobile communications terminal connected through the internet backbone network, and setting a security maintenance function for received contents;
a certification server for performing a user certification by receiving the signal from the security server;
a database for storing and managing data regarding the user certification; and
a call management exchanger for setting a call path according to a received number from the mobile communications terminal or a calling number to the mobile communications terminal, and setting a call to the set path.
